(19) United States
(12) Patent Application Publication
(10) Pub. No.: US 2008/0185842 A1
(43) Pub. Date: Aug. 7, 2008

(54) Dual-mode connection device

(76) Inventors: Gary Palmer Blackman, Carmel Valley, CA (US); Kent Brian Zilliox, Carmel Valley, CA (US)

Correspondence Address: Gary Blackman, 316 Mid-Valley Center, Carmel, CA, 93923, US

(21) Appl. No.: 11/703,345

(22) Filed: Feb. 6, 2007

(51) Int. Cl. F16L 17/02

(52) U.S. Cl. 285/376

(57) ABSTRACT

The invention provides a dual mode hose connection device which can be attached to standard threaded devices such as a typical garden hose faucet, and which offers a quick connection type of attachment as well. In one embodiment, a first dual mode connection piece is threaded onto a faucet. Once connected, standard garden hoses can be attached to the connector using a first mode comprising threaded fittings. In an alternative mode of usage, a second corresponding quick connection piece can be attached to the first connection piece, allowing rapid attachment and rapid removal of the second connection piece along with any desired devices or hoses which are connected down-line of the second piece. Thus, once a first dual mode connector piece is attached to a faucet, then either standard threaded hoses, or quick connect adapted hoses can be used without removing the first dual mode connection piece.

### FIELD OF THE INVENTION

The present invention relates to a device for quickly attaching any standard apparatus to the end of a standard garden hose or to a standard hose bib.

### BACKGROUND OF THE INVENTION

The invention relates to devices used for attaching any apparatus having a threaded connector to a second part having a counterpart threaded connector i.e. typical male/female threaded connectors, such as those used with garden hoses. In particular, the invention is useful for making the attachment process quicker and easier than with threaded connectors, while leaving the threaded connectors in place with the male threaded connector remaining available for use.

The long-standing standard method for attaching a hose to a fixed valve or faucet, such as a garden hose to a hose faucet, or for attaching an apparatus to the end of a hose or for attaching two hoses together is by means of conventional male/female threads. A rubber or rubber-like washer, compressed between the male and female fittings, provides a watertight seal with only finger-tight force being applied. While this method is certainly adequate, there are shortcomings. First, a basic risk of threaded connections is that of cross threading, resulting from the two sides not being properly aligned before force is applied to the connection operation. This condition fails to accomplish a successful connection and damages the threads in the process. Second, even proper alignment requires several revolutions of the female connector thread to draw the opposite sides into the compression washer for a successful connection. Third, proper alignment may be difficult to accomplish if the threads are fouled with debris or the apparatus to be connected is heavy and cumbersome. Finally, the exposed male thread, especially on a hose end, is prone to damage. It's threads may be compromised, or, through normal wear and tear, the entire threaded end may be compressed to an out-of-round state.

Some of the above-mentioned shortcomings have been addressed by a two-piece, quick-connect device commonly used on compressed air hoses and garden hoses. A first piece has two ends, including a standard female connector on one end for connecting to a hose faucet bib or the outer end of a hose, and on its outer end is a quick connect type male connector. Typically, the quick connect type male connector on the outer end also contains an O-ring.

The second piece also has two ends, with a standard male threaded connector on its outer end for connecting to a hose or any other apparatus containing a standard threaded connector, and on the other end is a quick connect type female connector. After each of the two pieces has been threaded onto its respective location, a connection between the two pieces is accomplished by simply pushing the two quick connect type ends together until they lock in place, with the O-ring providing the watertight seal. Typically, a sliding outer ring on the female quick connect end is pulled away from the connection to unlock the two quick connect ends.

While this standard quick connect type of connector device adds convenience to the attachment process, it eliminates the availability of the standard male connector for use with any hose or other apparatus that doesn't have its opposite side already attached. For example, if an operator approaches a hose bib that has this type of device attached, he must remove the device to expose the standard male thread before connecting any apparatus with a standard female thread. When the operation is completed he must reattached the device to return the hose bib to its former quick connect ready state.

Another shortcoming of this type of device is that it may fail if enough tensile force is applied to the connection. For example, when using a hose at full length, it's common for an operator to pull hard on the hose to maneuver it over an obstruction somewhere along its length. A low-cost, plastic version of the connector may separate under these circumstances.

### OBJECTS OF THE INVENTION

It is an object of the present invention to provide a device such that two parts of an apparatus which are normally joined with traditional male/female threaded connectors, can be connected with a quick-connect function, while also preserving the ready availability of the standard male thread when the female side of the present invention has been removed.

It is an object of the present invention to provide a device for air hoses and water hoses with quick-connect function, while preserving the ready availability of the standard male thread when the female side has been removed, i.e., an operator can approach the male side of the present invention and attach either an apparatus with a standard female thread, or the female side of the present invention.

It is a further object of the present invention to provide a device with quick-connect function, where the male side is inexpensive enough to be economically feasible to leave the male side attached in as many locations as required for convenient use, i.e., a swimming pool maintenance professional finds it economically feasible to leave a male side attached on the hose bib or hose end of each of his client locations, so he can conveniently and quickly attach his own equipment during his maintenance operations.

### SUMMARY OF THE INVENTION

The present invention provides a dual mode hose connection device which can be attached to standard threaded devices such as a typical garden hose or a garden hose faucet, and which can provide access for threaded attachment of hoses or devices, and which can also offer a quick connection type of attachment as well.

Garden hose faucets and garden hose attachment ends typically have coarse metal threaded connection elements. These threaded elements are matched with a corresponding opposite threaded element on the object to be attached, such as where a male threaded faucet hose bib has male threads, and a matching female threaded end of a garden hose can be attached to the male threaded element of the faucet hose bib. Similarly, two such garden hoses can be attached in series, by connecting a male threaded end to a female threaded end. Such garden hoses and threaded connectors are well known in the art. Dual mode connectors are a novel invention to be described herein.

Although the present invention can be designed for usage with garden hose type threads, the invention is also easily adaptable to be used with other types of threaded devices, with any type or dimensions of threads, as are known or can be devised by those skilled in the art. Thus other types of threaded devices can benefit from this invention, although for purposes of illustration the example of a dual mode garden hose connector shall be used for convenience and ease of understanding without limiting the scope of the invention to only that type of threaded devices.

In the present invention, a dual mode connection device is designed to connect to standard threaded elements in a first mode. In a second mode, a dual mode connection component can also be connected to a corresponding quick connection component. For example, a first dual mode connection piece can be threaded onto a faucet hose bib. Once connected, standard garden hoses can be attached to the connector using a first mode of garden threads. In an alternative second mode of usage, a second, corresponding quick connection device can be attached to the first connection piece, allowing rapid attachment and rapid removal of the second connection piece along with any desired devices or hoses which are connected down-line of the second piece. Thus, once a first dual mode connector piece is attached to a faucet hose bib, then either standard threaded hoses, or quick connect adapted hoses can be used without removing the first piece, saving time and energy for gardeners and maintenance professionals.

### BRIEF DESCRIPTION OF THE FIGURES

FIG. 1 depicts an inside view of a first piece of a dual mode connection device.

FIG. 2 depicts a bottom view of a first piece of a dual mode connection device.

FIG. 3 depicts a side view of a first piece of a dual mode connection device.

FIG. 4 depicts an inside view of a second piece of a dual mode connection device.

FIG. 5 depicts a bottom view of a second piece of a dual mode connection device.

FIG. 6 depicts a cross section view of a first piece and a second piece of a dual mode connection device when locked together.

FIG. 7 depicts an exploded view of a first piece, and a second piece of a dual mode connection device lined up prior to connection.

FIG. 8 depicts several sample embodiments, where a dual mode connection piece is constructed integrally with each of several possible common hose devices, in this case a dual mode connection piece integrated with a hose bib, a female hose end, a male hose end, and a typical hose-end accessory.

### DETAILED DESCRIPTION

A detailed description of a first embodiment of a dual mode connection device useful for garden hose type threads is provided. Clearly other types of threaded devices can employ the novel invention for dual mode connection.

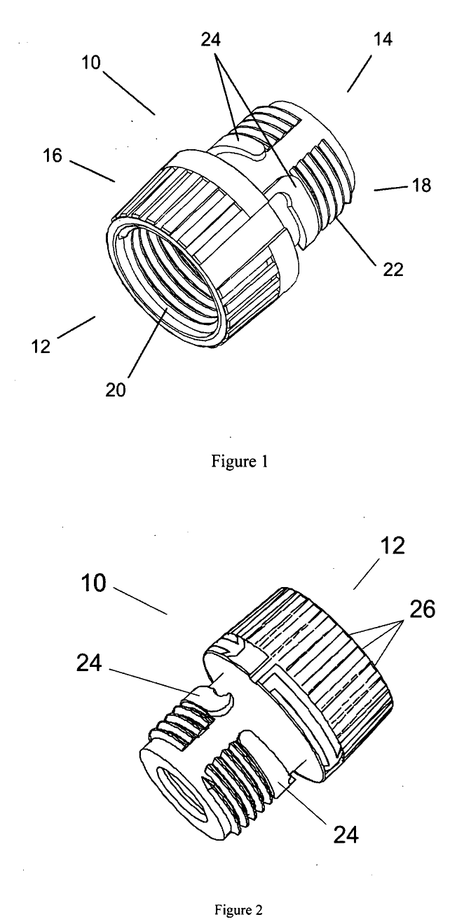

FIG. 1 depicts an inside view of a preferred embodiment of a first dual mode connection piece 10. The first connection piece 10 has a proximal end 12, and a distal end 14, and an inside region 16, and an outside region 18. In the present embodiment example, the inside 16 of the proximal end 12 has an inside female threaded portion 20. The example also depicts on the outside region 18 of the distal end 14, there is an outside male threaded region 22. The first dual mode connection piece 10 also has at least one quick connect locking system, depicted in FIG. 1 as a male quick connect locking element 24 on the outside region 16 of the first connection piece 10. Other types of quick connection elements can be used in different embodiments as are known or can be devised by those skilled in the arts.

FIG. 2 depicts a bottom view of the present embodiment of a first dual mode connection piece 10, with a clearer view of a preferred embodiment, showing a plurality of male quick connect locking elements 24. Also shown are raised rib elements 26 located on the proximal end 12, which are useful features for providing a firm grip on the first connection piece 10 when the first connection piece 10 is being attached to other components.

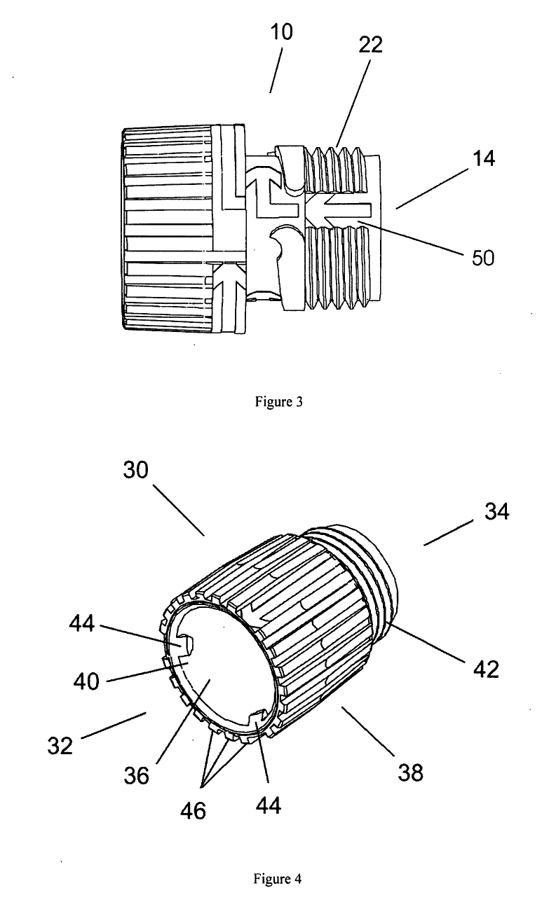

FIG. 3 depicts a side view of a first connection piece, where the outside male threaded region 22 on the distal end 14 of said first connection piece 10 is clearly shown.

In a first mode of usage, the inside female threaded portion 20 of a first dual mode connection piece 10 is screwed onto the exposed male threads of a typical garden hose faucet bib (not shown), just as any common garden hose or hose attachment would be screwed onto such a garden hose faucet bib. Once in place, the female threaded end of a garden hose (not shown) can be screwed onto the exposed outside male threaded region 22 of the first dual mode connection piece 10, in a first mode of connection, using only threaded portions of the first dual mode connection piece 10.

For using a second mode of connection, a second connection piece 30 is used, as shown in FIG. 4. FIG. 4 depicts an inside view of a preferred embodiment of a second dual mode connection piece 30. The second connection piece 30 has a proximal end 32, and a distal end 34, and an inside region 36, and an outside region 38. In the present embodiment example, the second dual mode connection piece 30 also has at least one quick connect locking system, depicted in FIG. 4 as a female quick connect locking portion 40 on the inside region 36 of the proximal end 32 of the second connection piece 30. The example also depicts on the outside region 38 of the distal end 34, there is an outside male threaded region 42. Within the female quick connect locking portion 40, there are also shown a plurality of raised female end locking elements 44. On the outside region 38 of the second connection piece 30 there can also be included raised rib elements 46 to enhance handling of the second connection piece 30 during attachment and dis-attachment operations.

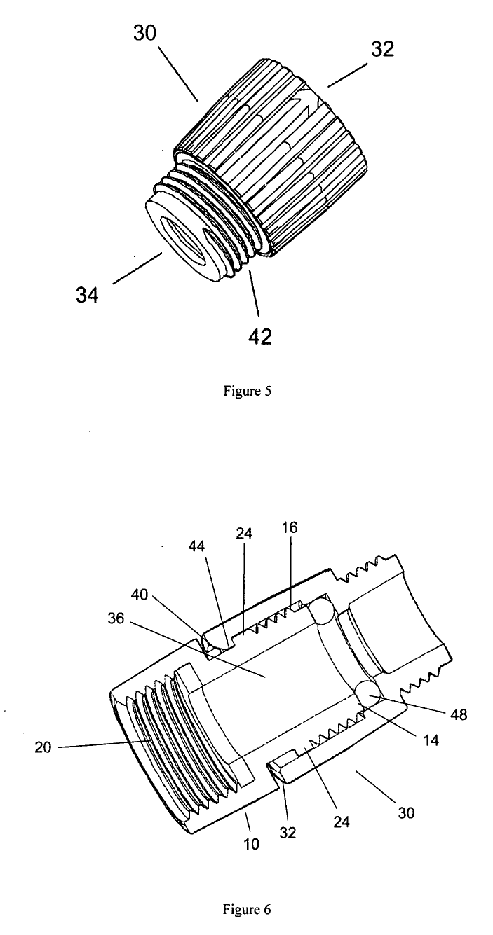

FIG. 5 depicts a bottom view of the present embodiment of a second dual mode connection piece 30, where the outside male threaded region 42 on the distal end 34 of said first connection piece 30 is clearly shown.

In a second mode of connection, which is novel to this invention, the inside female threaded portion 20 of a first dual mode connection piece 10 is screwed onto the exposed male threads of a typical garden hose faucet bib just as described above in the first mode of connection. However, in the second mode of connection for this present embodiment of the invention, a second dual mode connection piece 30 is connected to the first connection piece 10, as shown for a preferred embodiment, in a cross sectioned illustration in FIG. 6. As illustrated in the cross section view in FIG. 6, the distal end 14 of the first connection piece 10 fits within the inside region 36 of the proximal end 32 of a second dual mode connection piece 30. Connection is made in this embodiment between the first connection piece 10 and the second connection piece 30 with a twist-lock connection system comprising at least one male quick connect locking elements 24, shown on the outside region 16 of the first connection piece 10, and at least one corresponding female quick connect locking portion 40 shown on the inside region 36 of the proximal end 32 of the second connection piece 30, including in this embodiment at least one raised female end locking elements 44. A connection gasket 48 is used to make a water tight connection between the first piece 10 and the second piece 30.

In usage, a connection of such a first dual mode connection piece 10 and such a second dual mode connection piece 30 is accomplished by first pushing the distal end 14 of the first piece 10, into the inside region 36 of the proximal end 32 of the second connection piece 30. The first piece 10 is lined up with the second piece 30 such that the raised female end locking element(s) 44 of the second piece 30, are aligned with the gap(s) between male quick connect locking elements 24 of the first piece 10. When the first piece 10 is pushed into the second piece 30 until the two said pieces both connect to the connection gasket 48, the two said pieces are twisted in opposite directions relative to the other, such that raised element(s) 44 interlock with quick connect male element(s) 24, holding the two said connection pieces 10 and 30, firmly together, both in firm contact with the connection gasket 48.

FIG. 7 depicts such an embodiment as described above in exploded view, showing a first connection piece 10, a standard connection gasket 28, a second connection piece 30, and a connection gasket 48 aligned prior to enacting a connection.

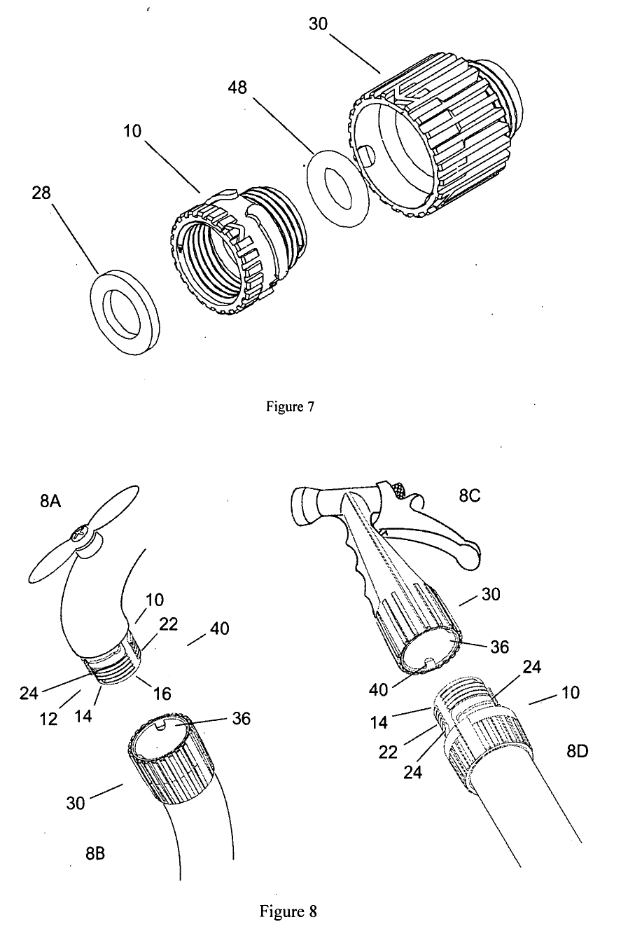

The device can have numerous embodiments. Each industry, where a quick, secure and versatile connection between a hose and the source, a device and a hose, or two or more hoses, will contribute to speed or convenience, may have its own embodiment. The device can be manufactured in various sizes. The device can function as described in various configurations and shapes, either as stand alone devices, or integrally affixed, such as molded into hose ends and hose-related devices, so as to become integral with them as shown in FIG. 8. In embodiments where the inventive device is made integrally affixed with a hose or hose attachment accessory device, the dual mode connection pieces 10 or 30 can be manufactured or molded directly onto a hose, a hose bib, or a hose attachment device, in place of simple hose attach threads. A hose bib thusly built, for example, with a dual mode connection piece 10 integrally affixed, would provide dual mode attachment options rather than simple standard threads.

In the case of a dual mode connection piece 10 which is integrally affixed to a hose or to a hose accessory, such as shown in FIG. 8, the inside region 16 would not need the female threaded portion 20 which was shown in FIG. 6, but rather instead of the inside female threaded portion 20, the connection piece 10 would be integrally affixed, such as to a hose bib, a hose end or a hose attachment accessory.

FIG. 8 depicts several sample embodiments, where a dual mode connection piece is constructed integrally with several possible common hose devices (although many others not shown are possible within the scope of the invention). FIG. 8A shows a dual mode connection piece 10 integrated with a hose bib. FIG. 8B shows a dual mode connection piece 30 integrated with a female hose end. FIG. 8C shows a dual mode connection piece 30 integrated with a female hose accessory. FIG. 8D shows a dual mode connection piece 10 integrated with a typical male hose-end.

In a slightly modified useful embodiment, which is shown clearly in FIG. 3, the first connection piece 10 can be made where the outside male threaded region 22 can be built to include a split thread which forms at least one thread gap 50. This thread gap 50 is useful when a first connection piece 10 is used in conjunction with a twist lock type of second connection piece 30 which has at least one raised female end locking element 44. The thread gap 50 is designed with dimension sufficient to allow a raised female end locking element 44 to slide up along the length of the thread gap 50 when the first connection piece 10 is coupled to the second connection piece 30. With this described configuration including a thread gap 50, the inside diameter, and the overall size of the second connection piece can be made slightly smaller and more compact than if a thread gap 50 were not included. In the case where a thread gap 50 is not included, the diameter and overall size of a second connector piece 30 would need to be sufficiently large, so that a raised female end locking element 44 would have clearance to slide over the male threaded region 22 of a first connection piece 10 when the first connection piece 10 is coupled to a second connection piece 30 which included such twist lock connection features.

Materials used to manufacture this inventive device can be metal, plastic, rubber or any material suitable for construction of the device. In a currently preferred embodiment, each of the components of the present embodiment described for example herein can be made using molded plastic parts as are well known in the industry. Additional methods of manufacture can include molding, welding, milling, screwing, bonding, gluing, friction, or any method suitable for construction of the device. The device may contain other attached or attachable devices or pieces. Any applicable feature of any version of the device may be employed on any other version.

For other embodiments of a second mode of attachment for dual mode connection devices, alternative connection arrangements are possible, as are known or can be devised by those skilled in the arts and should be deemed to fall within the scope and the spirit of the present invention.

1) A dual-mode hose connection device comprising;
A first dual-mode connection piece comprising,
An inside, an outside, and a proximal end, and a distal end,
where the inside of the proximal end comprises a female threaded portion, and,
where the outside of the distal end comprises a male threaded portion, and,
where the first dual mode connection piece further comprises at least one element of a quick connect hose locking system.

2) A dual-mode hose connection device as in claim 1, where at least one portion of the quick connect hose locking system comprises at least one element of a twist-lock type quick connect system.

3) A dual-mode hose connection device as in claim 1, where at least one portion of the quick connect hose locking system comprises at least one raised element on the outside of one of the quick connect pieces.

4) A dual-mode hose connection device as in claim 3 comprising more than one raised element on the outside of one of the quick connect pieces.

5) A dual-mode hose connection device as in claim 1, further comprising a second connection piece, said second connection piece comprising,
An inside, an outside, and a proximal end, and a distal end,
where the outside of the distal end of said second connection piece comprises a male threaded portion, and,
where the proximal end of the second connection piece further comprises at least one portion of a quick connect hose locking system.

6) A dual-mode hose connection device as in claim 5
where the inside of the proximal end of said second connection piece comprises a female quick connect portion, and the outside of the first connection piece comprises a male quick connect portion.

7) A dual mode hose connection device as in claim 1,
Where at least one end of the inside region would be integrally affixed to a hose.

8) A dual mode hose connection device as in claim 7,
Where at least one end of the inside region would be integrally affixed to a hose, and
Where the inside region of said dual mode hose connection device would not have an inside female threaded portion.

9) A dual mode hose connection device as in claim 1,
Where at least one end of the inside region would be integrally affixed to a hose bib, and
Where the inside region would not have an inside female threaded portion.

10) A dual mode hose connection device as in claim 1,
Where at least one end of the inside region would be integrally affixed to a hose attachment accessory

11) A two piece dual mode connection device comprising;
A first dual-mode connection piece comprising,
a female threaded portion, and,
a male threaded portion, and,
which further comprises at least one portion of a quick connect locking system.

12) A two piece dual mode connection device as in claim 11, where at least one portion of said quick connect locking system comprises at least one twist lock type connection element.

13) A two piece dual mode connection device as in claim 11, which further comprises a second connection piece, where said second connection piece comprises a threaded male portion and at least one part of a quick connect locking system.

14) A dual-mode connection device as in claim 13, where at least one portion of the quick connect locking system comprises at least one twist-lock type quick connect element.

15) A two piece hose connection device comprising;
A first hose connection piece comprising,
a female threaded portion, and,
a male threaded portion, and,
which further comprises at least one portion of a quick connect locking system.

16) A two piece hose connection device as in claim 15, where at least one portion of said quick connect locking system comprises at least one twist lock type connection element.

17) A two piece hose connection device as in claim 15, which further comprises a second connection piece, where said second connection piece comprises a threaded male portion and at least one part of a quick connect locking system.

18) A hose connection device as in claim 17, where at least one portion of the quick connect locking system comprises at least one twist-lock type quick connect element.

19) A two piece connection device comprising,
A connection piece comprising,
a female threaded portion, and,
a male threaded portion, and,
which further comprises at least one portion of a quick connect locking system.

20) A two piece connection device as in claim 19,
Further comprising a male threaded portion where said male threads are split to form at least one thread gap.
